(19) United States
(12) Patent Application Publication
(10) Pub. No.: US 2010/0200369 A1
(43) Pub. Date: Aug. 12, 2010

(54) METHOD AND APPARATUS FOR CLEANING THE CHIP CONVEYOR OF A MACHINE TOOL

(75) Inventor: Esko SUUTARINEN, Vantaa (FI)

Correspondence Address: BIRCH STEWART KOLASCH & BIRCH, PO BOX 747, FALLS CHURCH, VA, 22040-0747, US

(73) Assignee: CITY WORLD TRADING LTD OY, Kerava (FI)

(21) Appl. No.: 12/617,171

(22) Filed: Nov. 12, 2009

(30) Foreign Application Priority Data
Feb. 10, 2009 (FI) U20090055

(51) Int. Cl. B65G 45/22

(52) U.S. Cl. 198/495

(57) ABSTRACT

Method and apparatus for cleaning (6) the chip conveyor (2) of a machine tool, in which method the machining chips are transported with the chip conveyor (2) to the discharge end of the chip conveyor, where the path of movement of the chip conveyor (2) turns backwards towards the machine tool. The apparatus comprises at least a cleaner (6), which comprises pneumatically operated cleaning means (8) for removing chips from the chip conveyor (2) such that compressed air is blown onto the bottom surface of the chip conveyor (2).

The present invention relates to a method as presented in the preamble of claim 1 and an apparatus as presented in the preamble of claim 6 for cleaning a chip conveyor of a machine tool.

The invention is well suited for use in the chip removal of tray conveyors, which are intended for chip transport and are in connection with machine tools, at the discharge end of the tray conveyor, though the solution according to the invention is suited for chip removal also from other types of conveyors and at other points of the conveyor.

One problem in the chip removal of machine tools is that all the chips do not leave the surface of the conveyor that is made wet by cooling fluid at the discharge end of the chip conveyor, in which case the chips that are caught travel back into the cooling fluid reservoir and detach there and at the same time fill, and before long block, the cooling fluid reservoir. The problem occurs especially when machining a material that forms short chips, such as free-cutting steels, free-cutting alloy, brass and cast iron. For this reason the cooling fluid reservoir must often be emptied, which is a time-consuming procedure and thus reduces the capacity of the machine tool. Another problem is that many metal chips in the cooling fluid reservoir discolor the cooling fluid, in which case the machining of all materials after this is no longer necessarily possible. Discoloring metal chips are e.g. brass chips, bronze chips, aluminium chips and cast iron chips, which when in the cooling fluid reservoir in large quantities discolor the fluid easily so that it is unusable. In addition, a problem is that e.g. brass chipping mixed up with other chips is not recyclable. Thus all the brass chipping cannot be properly recycled. The same applies to other metal chips.

It has been attempted to resolve the problem according to prior art with, among other things, separate rotating or non-rotating brushes disposed in connection with the discharge end of the conveyor; a drawback in all these is that the bristles of the brushes quickly clog, in which case cleaning no longer functions. Additionally, the brushes wear quickly, so that the use of brushes is not in practice viable.

The purpose of this invention is to eliminate the aforementioned drawbacks and to achieve a method and an apparatus for cleaning the chip conveyor of a machine tool that are as inexpensive and simple as possible, as well as being operationally reliable and efficient. The purpose of the invention is also to achieve a cleaner that can be quickly installed into position and can be adjusted in its fixing in a versatile manner, which enables fixing of the cleaner to many different-sized structures. The method according to the invention is characterized by what is disclosed in the characterization part of claim 1. Likewise the apparatus according to the invention is characterized by what is disclosed in the characterization part of claim 6. Other embodiments of the invention are characterized by what is disclosed in the other claims.

An advantage of the cleaner according to the invention is that since it is pneumatically operated it is simple in structure and operationally reliable, and it does not comprise wearing parts. In addition, the strength and direction of the air jet that removes the chips are if necessary easy to adjust. Another advantage is that the cleaner can easily be fitted to all the machine tools on the market that comprise a chip conveyor needed for chip removal. From this follows the advantage, among other things, of an increase in the total capacity of machine tools, because the cooling fluid reservoir does not need to be cleaned so often.

In the following, the invention will be described in more detail by the aid of one of its embodiments with reference to the attached drawings, wherein

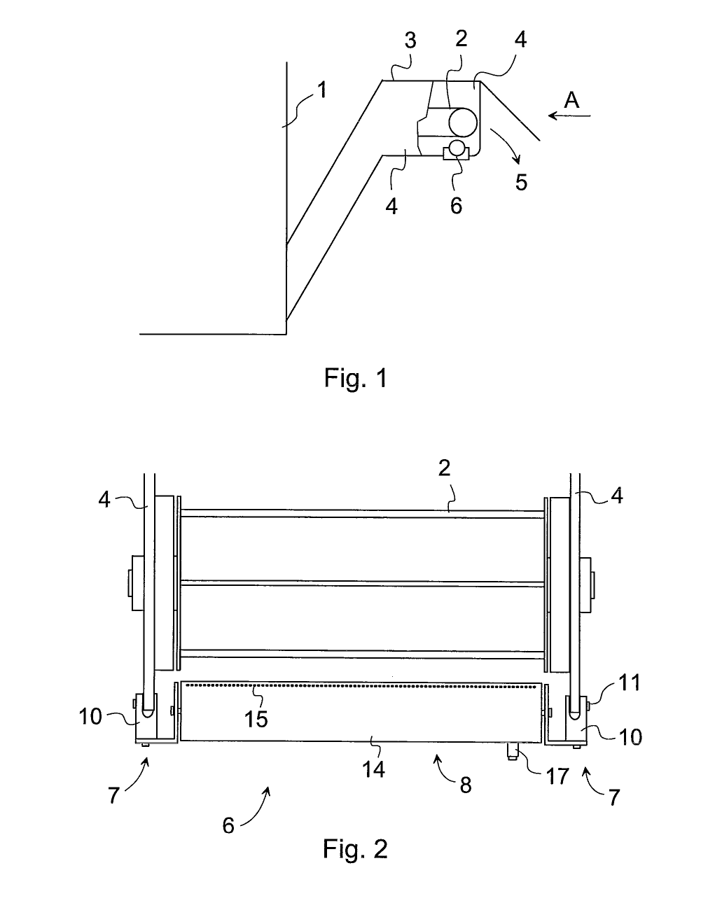

FIG. 1 presents a simplified and partially sectioned side view of the discharge end of a chip conveyor of a machine tool, which comprises a chip cleaner according to the invention,

FIG. 2 presents a simplified and partially sectioned view of the discharge end of the chip conveyor according to FIG. 1 as seen from the direction of the arrow A in FIG. 1, and

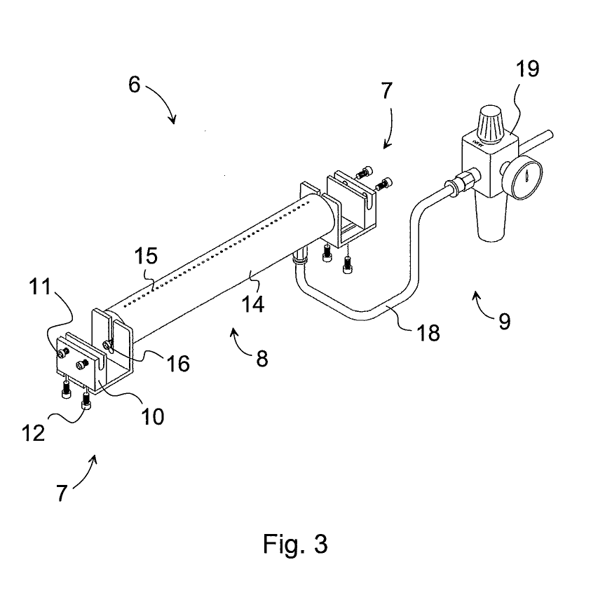

FIG. 3 presents an oblique top view of one chip cleaner according to the invention when detached.

FIG. 1 presents a simplified view of the discharge end of a chip conveyor 2 of a machine tool 1 with the side plate 4, on the side of the viewer, of the enclosure 3 of the chip conveyor 2 partially sectioned. An endless chip conveyor 2 consisting of trays brings the machining chips on its top surface to the discharge end, where the path of movement of the chip conveyor 2 turns backwards traveling via a cooling fluid reservoir under the object to be machined and again out to the discharge end. The cooling fluid reservoir is not presented in the figure. The chips drop at the discharge end from the aperture of the enclosure 3 essentially in the direction of the arrow 5 into a collection container below, which is not shown in the figure. To improve the efficiency of the cleaning of the chip conveyor 2 a pneumatically operated apparatus that functions as a cleaner 6 of the chip conveyor 2 is disposed at the discharge end of the chip conveyor 2, which apparatus is arranged to blow compressed air onto the bottom surface of the chip conveyor 2. A suitable blowing angle is e.g. from below at an angle upwards towards the path of movement of the chip conveyor 2, in which case detachment of the chips is more efficient and the detached chips fly out of the aperture of the discharge end into the collection container.

FIG. 2 presents in more detail the discharge end of the chip conveyor 2 and the cleaner 6 fixed into its position and FIG. 3 presents the cleaner 6 when detached. The main parts of the cleaner 6 are the fixing means 7, the pneumatically operated cleaning means 8 and the compressed air supply means 9. There is one fixing means 7 at each end of the cleaner 6 and by means of them the cleaner 6 is fixed to the bottom edge of the side plates 4 of the enclosure 3 of the chip conveyor or to some other suitable fixing point.

The fixing means 7 comprise at least an adjustable fixing element 10 in the width direction of the chip conveyor 2, and an adjustment means 8 shaped as an L-profile forming the base of the fixing element. The fixing element 10 is fixed to the grooves in the base of the adjustment means 8 at a suitable point in the width direction of the chip conveyor 2 by means of fixing screws 12. The fixing element 10 itself, and at the same time the whole cleaner 6, is fixed to the bottom edge of the side plate 4 of the adjustment enclosure 3 with fixing screws 11.

The pneumatic cleaning means 8 comprise at least a compressed air body 14, which is e.g. a hollow cylindrical tube closed at its ends, and a plurality of holes 15 in an essentially straight line in the axial direction of the tube, which extend through the wall of the tube. In addition, a compressed air connector 17 for supplying compressed air to the hollow inner space of the compressed air body 14 is connected to the compressed air body 14.

The compressed air body 14 is fixed at its ends between the vertical sides of the adjustment means 8 into grooves in the vertical sides with the fixing screws 16 such that the vertical distance of the top surface of the compressed air body 14 from the bottom surface of the chip conveyor 2 can be adjusted. Likewise the fixing enables rotation of the compressed air body 14 around the axis formed by the fixing screws 16 when it is desired to adjust the row of holes 15 to the correctly angled position with respect to the bottom surface of the chip conveyor 2.

The supply means 9 of the compressed air comprise at least an air hose 18 and regulation means 19 of the compressed air. The air hose 18 is connected at its first end to the compressed air connector 17 of the compressed air body 14 and at its second end to the regulation means 19 of the compressed air, from where there is further contact to the production of compressed air.

In one preferred embodiment of the invention a switching means suited to the purpose, such as e.g. a magnetic valve or corresponding actuator, is in connection with the regulation means 19 of the compressed air, which switching means is fitted to control the regulation of the compressed air such that when the chip conveyor 2 is switched to intermittent infeed the compressed air blowing is switched on only when the chip conveyor is moving and the blowing is switched off when the chip conveyor stops.

With the method according to the invention the chip conveyor 2 is cleaned by directing compressed air onto the bottom surface of the chip conveyor 2 at the discharge end of the chip conveyor 2 when the point to be cleaned is coming towards the cooling fluid reservoir again after the discharge end. Compressed air is blown via the holes 15 in the compressed air body 14 at a suitable angle, e.g. from below at an angle upwards towards the bottom surface of the chip conveyor 2, in the opposite direction with respect to the path of movement of the chip conveyor 2, in which case detachment of the chips is more efficient and the detached chips fly out of the aperture of the discharge end into a collection container.

In one preferred embodiment of the invention a switching means suited to the purpose, such as e.g. a magnetic valve or corresponding actuator, is used, with which the regulation of the compressed air is controlled such that when the chip conveyor 2 is switched to intermittent infeed the compressed air blowing is switched on only when the chip conveyor 2 is moving and the blowing is switched off when the chip conveyor 2 stops.

It is obvious to the person skilled in the art that the invention is not limited solely to the example described above, but that it may be varied within the scope of the claims presented below. Thus compressed air can be blown also onto the top surface of the chip conveyor instead of onto the bottom surface, or directly towards the surface of the chip conveyor at the discharge end. When blowing compressed air onto the top surface of the chip conveyor the blowing direction must be essentially in the direction of movement of the chip conveyor, although the blowing direction can be at an inclined attitude with respect to the top surface of the chip conveyor.

It is further obvious to the person skilled in the art that the fixing structures of the chip cleaner can be different to what is presented above.

It is also obvious to the person skilled in the art that there can be more than one row of holes in the compressed air body. For example, two or three.

It is further obvious to the person skilled in the art that the compressed air body can be of another cross-sectional shape than cylindrical, e.g. square, rectangular or elliptical.

It is also obvious to the person skilled in the art that the shape of the holes in the compressed air body can be varied. The shape can be e.g. round, oval, drop-shaped or e.g. elongated.

1. Method for cleaning the chip conveyor of a machine tool, in which method the machining chips are transported with the chip conveyor to the discharge end of the chip conveyor, where the path of movement of the chip conveyor turns backwards towards the machine tool, wherein the chip conveyor is cleaned by directing compressed air towards the surface of the chip conveyor.

2. Method according to claim 1, wherein the chip conveyor is cleaned by directing compressed air at the bottom surface of the chip conveyor in the proximity of the discharge end of the chip conveyor.

3. Method according to claim 1, wherein compressed air is blown onto the bottom surface of the chip conveyor at the discharge end of the chip conveyor when the point to be cleaned is coming towards the cooling fluid reservoir again after the discharge end.

4. Method according to claim 1, wherein compressed air is blown via the holes in the compressed air body at a suitable angle, e.g. from below at an angle upwards towards the bottom surface of the chip conveyor, in the opposite direction with respect to the path of movement of the chip conveyor.

5. Method according to claim 1, further comprising a switching means suited to the purpose, such as with a magnetic valve or corresponding actuator, the regulation of the compressed air is controlled such that when the chip conveyor is switched to intermittent infeed the compressed air blowing is switched on only when the chip conveyor is moving and the blowing is switched off when the chip conveyor stops.

6. Apparatus for cleaning the chip conveyor of a machine tool, which apparatus comprises at least a cleaner and fixing means for fixing the cleaner in connection with the chip conveyor, wherein the cleaner comprises pneumatically operated cleaning means for removing chips from the chip conveyor.

7. Apparatus according to claim 6, wherein the cleaner comprises an essentially tubular compressed air body, which is provided with a plurality of holes in an essentially straight line in the axial direction of the compressed air body.

8. Apparatus according to claim 6, wherein the cleaner comprises fixing means for fixing the cleaner to the bottom side of the chip conveyor.

9. Apparatus according to claim 6, wherein the cleaner is arranged to be fixed to the bottom side of the chip conveyor near the discharge end of the chip conveyor such that the holes are aligned at an angle upwards towards the bottom surface of the chip conveyor.

10. Apparatus according to claim 6, wherein a switching means, such as a magnetic valve or corresponding, is in connection with the regulation means of the compressed air, which switching means is fitted to control the regulation of the compressed air such that when the chip conveyor is switched to intermittent infeed the compressed air blowing is switched on when the chip conveyor is moving and off when the chip conveyor stops.
